(19) United States
(12) Patent Application Publication
(10) Pub. No.: US 2017/0012978 A1
(43) Pub. Date: Jan. 12, 2017

(54) SECURE COMMUNICATION METHOD AND APPARATUS

(71) Applicant: RIVER SECURITY INC., Shanghai (CN)

(72) Inventors: Yumin LIN, Shanghai (CN); Hongyong XIAO, Shanghai (CN); Lin ZHENG, Shanghai (CN); Ming Xu, Shanghai (CN)

(73) Assignee: RIVER SECURITY INC., Shanghai (CN)

(21) Appl. No.: 15/147,780

(22) Filed: May 5, 2016

(30) Foreign Application Priority Data
May 14, 2015 (CN) 201510243743.6

(51) Int. Cl. H04L 29/06

(52) U.S. Cl. CPC H04L 63/0884; H04L 63/0428; H04L 63/062; H04L 63/0281; H04L 63/1408; H04L 63/1466; G06F 2221/2151

(57) ABSTRACT

The present invention provides a secure communication method and apparatus. A security proxy device is arranged between a client and a server; after receiving data returned by the server to the client, the security proxy device assigns a token to the client, and sends the token, the data returned by the server to the client and an execution module to the client; receives a request which the execution module running at the client uses the token to send, verifies the token, and forwards the request to the server if the validation succeeds. The present invention improves security of communication between the client and the server, and can protect the server from various automated attacks.

### FIELD OF THE INVENTION

The present invention relates to the technical field of data security, and particularly to a secure communication method and apparatus.

### BACKGROUND OF THE INVENTION

As network technology develops rapidly, previous communication between either a client of mobile equipment or a client of a PC and a server is confronted with serious security issues. The security issues mainly involve automated attack to the server, leakage of communication data, illegal Man-in-the-Middle Attack to the server, an illegal client's access to the server, and the like.

### SUMMARY OF THE INVENTION

In view of the above, the present invention provides a secure communication method and apparatus to assist in improving security of communication between the client and the server.

Specific technical solutions are as follows:

The present invention provides a secure communication method which is executed by a security proxy device between the client and the server, the method comprising:

S1: after receiving data returned by the server to the client, assigning a token to the client and sending the token, the data returned by the server to the client and an execution module to the client;

S2: receiving a request which the execution module running at the client uses the token to send, validating the token, and forwarding the request to the server if the validation succeeds.

According to a preferred embodiment of the present invention, the method further comprises:

after receiving the request sent by the client to the server, judging whether a valid token has already been assigned to the client, and forwarding the request to the server if no; judging whether the request carries a token if yes, and executing a step of validating the token if the request carries the token.

According to a preferred embodiment of the present invention, the method further comprises:

performing validation for the request, and refusing to process the request if the validation fails.

According to a preferred embodiment of the present invention, the validation comprises any one or any combination of the following:

validating whether a protocol header of the request complies with a protocol-specified type;

performing grammar validation to the protocol header of the request and the request address;

validating whether the protocol header of the request and the request address include an attack code; and

performing authentication to the request address of the request.

According to a preferred embodiment of the present invention, the assigning the token to the client comprises: using an access token key to encrypt data containing the access key to obtain an access token;

In the step S2, the request sent by the execution module carries the access token.

According to a preferred embodiment of the present invention, the data containing the access key further comprises any one or any combination of the following data:

a Timestamp, a Token Serial number, a Hash value of a request address and a Client Status Value;

wherein the Client Status Value is configured according to whether the request sent by the client carries a correct token or whether it is valid.

According to a preferred embodiment of the present invention, the token assigned to the client further comprises a Client Status Request Token;

What are sent to the client in the step S1 further comprise the Client Status Request Token and a Client Status Request Key;

Between the step S1 and the step S2, the method further comprises:

S31: receiving the Client Status Request Token sent by the execution module;

S32: after confirming that the Client Status Request Token is valid, assigning a Client Status Token to the client, and sending to the client the Client Status Token encrypted by using the Client Status Request Key;

In the step S2, the request sent by the execution module further carries the Client Status Token.

According to a preferred embodiment of the present invention, the Client Status Request Token is obtained by using a Client Status Request Token Key to encrypt the data containing the Client Status Request Key.

According to a preferred embodiment of the present invention, in the step S2, the validating whether the Client Status Request Token is valid comprises:

judging whether the received Client Status Request Token is the Client Status Request Token assigned for the client and has not yet been used by the client, confirming that the Client Status Request Token is valid if yes; otherwise confirming that the Client Status Request Token is invalid.

According to a preferred embodiment of the present invention, the Client Status Request Key comprises: a Client Status Request Encryption Key and a Client Request Hash Key;

In said S32, the Client Status Request Encryption Key is used to encrypt the Client Status Request Token;

Said S31 further comprises receiving a random number encrypted by using the Client Status Request Encryption Key and a Hash value obtained by using the Client Request Hash Key to hash the random number;

Said S32 further comprises: using the Client Status Request Encryption Key to decrypt the received random number, and then validating the decrypted random number by using the Hash value; and executing the step of assigning the Client Status Token to the client after the validation succeeds.

According to a preferred embodiment of the present invention, in the step S2, forwarding of the request is refused if the validation of the token fails or the received request does not carry the token.

According to a preferred embodiment of the present invention, what are sent to the client in the step Si further comprise: an illegal attack trapping module containing a bogus URL;

If a request with respect to the bogus URL is detected, it is determined that the client sending the request with respect to the bogus URL is an attacking client.

According to a preferred embodiment of the present invention, the step S1 further comprises: sending the Access Key to the client;

In the step S2, the forwarding the request to the server comprises: using the Access Key to decrypt the data contained by the request, and forwarding the decrypted request to the server.

The present invention further provides a secure communication apparatus arranged between the client and the server. The apparatus comprise: a response processing unit, a token management unit and a request processing unit;

The response processing unit is used to receive the data returned by the server to the client, and send the token assigned to the client, the data returned by the server to the client and the execution module to the client.

The token management unit is used to assign the token to the client after the response processing unit receives the data returned by the server to the client; verify the token provided by the request processing unit.

The request processing unit is used to receive a request which the execution module running at the client uses the token to send, provide the token to the token management unit, and forward the request to the server if the token validation succeeds.

According to a preferred embodiment of the present invention, the request processing unit is further used to receive the request sent by the client to the server, then trigger the token management unit to judge whether a valid token has already been assigned to the client, and forward the request to the server if a judgment result of the token management unit is no; judge whether the request carries a token if the judgment result of the token management unit is yes, and execute an operation of providing the token to the token management unit if the request carries the token.

According to a preferred embodiment of the present invention, the request processing unit is further configured to perform validation for the request, and refuse to process the request if the validation fails.

According to a preferred embodiment of the present invention, the request processing unit is further configured to execute any one or any combination of the following validations to the request:

validating whether a protocol header of the request complies with a protocol-specified type;

performing grammar validation to the protocol header of the request and the request address;

validating whether the protocol header of the request and the request address include an attack code; and

performing authentication to the request address of the request.

According to a preferred embodiment of the present invention, upon assigning a token to the client, the token management unit specifically uses an access token key to encrypt data containing the access key to obtain an access token;

The request sent by the execution module carries the access token.

According to a preferred embodiment of the present invention, the data containing the access key further comprises any one or any combination of the following data:

a Timestamp, a Token Serial number, a Hash value of a request address and a Client Status Value;

wherein the Client Status Value is configured according to whether the request sent by the client carries a correct token or whether it is valid.

According to a preferred embodiment of the present invention, the apparatus further comprises: a status validation unit;

Upon assigning the token to the client, the token management unit further assigns a Client Status Request Token; and after being triggered by the status validation unit, assigns a Client Status Token to the client;

When the response processing unit sends the token assigned to the client, the data returned by the server to the client and the execution module to the client, it further sends the Client Status Request Token and a Client Status Request Key;

The status validation unit is configured to receive the Client Status Request Token sent by the execution module; after confirming that the Client Status Request Token is valid, trigger the token management unit to assign the Client Status Token to the client; and send to the client the Client Status Token encrypted by using the Client Status Request Key;

The request sent by the execution module further carries the Client Status Token.

According to a preferred embodiment of the present invention, upon assigning the Client Status Token to the client, the token management unit specifically uses the Client Status Request Token Key to encrypt the data containing the Client Status Request Key to obtain the Client Status Token.

According to a preferred embodiment of the present invention, upon validating whether the Client Status Request Token is valid, the status validation unit is specifically used to:

judge whether the received Client Status Request Token is the Client Status Request Token assigned for the client and has not yet been used by the client, confirm that the Client Status Request Token is valid if yes; otherwise confirm that the Client Status Request Token is invalid.

According to a preferred embodiment of the present invention, the Client Status Request Key comprises: a Client Status Request Encryption Key and a Client Request Hash Key;

Said status validation unit specifically uses the Client Status Request Encryption Key to encrypt the Client Status Token;

Said status validation unit further receives a random number encrypted by using the Client Status Request Encryption Key and a Hash value obtained by using the Client Request Hash Key to hash the random number; uses the Client Status Request Encryption Key to decrypt the received random number, and then verifies the decrypted random number by using the Hash value; and executes the operation of the triggering the token management unit to assign the Client Status Token to the client after the validation succeeds.

According to a preferred embodiment of the present invention, the request processing unit refuses to forward the request if the validation of the token fails or the received request does not carry the token.

According to a preferred embodiment of the present invention, upon sending the token assigned to the client, the data returned by the server to the client and the execution module to the client, the response processing unit further sends an illegal attack trapping module containing a bogus URL;

The apparatus further comprises an illegal attack detection unit used to, if a request with respect to the bogus URL is detected, determine that the client sending the request with respect to the bogus URL is an attacking client.

According to a preferred embodiment of the present invention, upon sending the token assigned to the client, the data returned by the server to the client and the execution module to the client, the response processing unit further sends the Access Key to the client;

The request processing unit, upon forwarding the request to the server, uses the Access Key to decrypt the data contained by the request, and forwards the decrypted request to the server.

As can be seen from the above technical solutions, the security proxy device is arranged between the client and server, the security proxy device completes the forwarding of a request and data between the client and the server, the execution module is arranged in the client to enable the client to use the security proxy device to send a request for a token assigned to the client, thereby achieving the access control of the client, improving security of communication between the client and the server, and effectively ensuring security of the server.

### BRIEF DESCRIPTION OF DRAWINGS

FIG. 1 is a schematic structural diagram of a system which the present invention is based on;

FIG. 2 is a flow chart of a method according to an embodiment of the present invention;

FIG. 3 is a block diagram of an apparatus according to an embodiment of the present invention.

### DETAILED DESCRIPTION OF PREFERRED EMBODIMENTS

The present invention will be described below in detail with reference to figures and specific embodiments to make objects, technical solutions and advantages of the present invention more apparent.

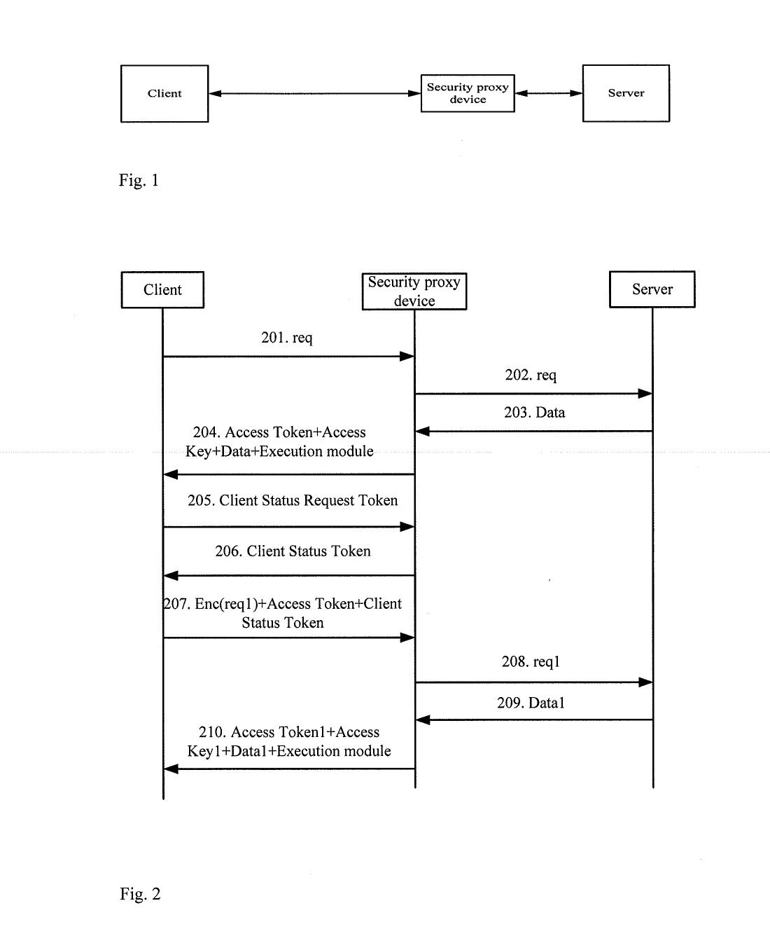

An embodiment of the present invention is based on system architecture as shown in FIG. 1. In this system, a security proxy device (which may be hardware, software, a virtual machine or the like) is arranged between a client and a server, the security proxy device, as an intermediate device, is responsible for communication security between the client and the server, and interaction data between the client and the server must be forwarded via the security proxy device. To implement the security proxy device's forwarding of interaction data between the client and the server, network setting manners may employ the following network setting manners in advance but are not limited to the following network setting manners:

The first manner: networking the security proxy device at an entrance position to the server so that the interaction data between the client and server must go through the security proxy device.

The second manner: setting in a Domain Name System DNS to parse a domain name to be sent to the server as an IP address of the security proxy device such that data transmitted to the server will be transmitted to the security proxy device, and then setting to allow all data received by the security proxy device from the client to be transmitted to the server.

In the embodiment of the present invention, functions of the security proxy device are mainly manifested in the following aspects. Implementation of specific functions will be described in detail in subsequent embodiments.

1) Regarding a request sent by a client for which a token has not yet been assigned, if the access is designated an entry (i.e., the request is a request transmitted by the client to the designated server), directly forwarding the request to the server, and forwarding return data from the server to the client; otherwise, rejecting the request.

2) Performing validation for security of the request or data content.

3) Upon forwarding return data from the server to the client, assigning a token and a token key to the client, and sending an execution module together with data to the client.

4) Using the token key assigned to the client to decrypt the request sent by the client.

5) Upon receiving the request sent by the client, performing access control for the client based on the token sent along with the request.

FIG. 2 is a flow chart of a method according to an embodiment of the present invention. As shown in FIG. 2, the method may comprise the following steps:

In 201, the security proxy device receives a request from the client, the request being represented as req, performing validation to the request, and proceeding to execute 202 upon success to pass the validation; refusing to process the request if the validation fails.

Wherein the validation to the request may comprise, but not limited to:

1) Performing validation for a protocol header of the request, namely, validating whether it complies with a protocol-specified type, passing the validation if it does, otherwise the validation fails.

2) Validating the header of the request and a grammar of a request address, i.e., validating whether its grammar complies with a protocol-specified grammar requirement, the validation succeeds if the grammar complies with the requirement, otherwise the validation fails. The request address here refers to a requested source address, and may be embodied as URL.

3) Validating whether the header of the request and the request address contain attack content, i.e., validating whether they contain an attack code: the validation fails if they do, otherwise the validation succeeds. The validation may be implemented based on a blacklist or characteristics of the attack code.

4) Performing authentication for the request address in a whitelist manner or blacklist manner, for example, validating whether the request address is in the whitelist: the validation succeeds if the request address is in the white list, otherwise the validation fails.

In 202, the security proxy device forwards the request to the server.

According to the situations shown in 201-202, the client sends a request to the security proxy device for the first time, the security proxy device has not yet assigned a token to the client, and the security proxy device directly forwards the client's request to the server if the request is sent to a designated server.

If the request sent by the client is not sent to the designated server, the security proxy device may refuse the request.

In addition, in the security proxy device the return data from the server is stored locally, so before the request is forwarded to the server, it may be judged first whether the data requested by the request is stored locally and latest data: if yes, the security proxy device may directly use the locally-stored data to execute 204, otherwise execute 203. Wherein whether locally-stored data is the latest data may be judged according to aging time of the data, or judged by interacting data version number with the server. Detailed description will not be presented any more here.

In 203, the security proxy device receives return data from the server, which is identified as Data in the figure. Validation may be further performed for the data, e.g., verify whether the data includes attack content, verify correctness of the data, and the like. If validation succeeds, the server may execute 204, and furthermore, the data may be stored locally on the security proxy device.

In 204, the security proxy device assigns the token and the token key to the client, and sends the token, the token key, return data from the server and the execution module to the client.

The assigned token may comprise an Access Token which may be obtained by using an access token key tek-AT to encrypt data containing an Access Key. For example, the Access Token may be obtained by using tek-AT to encrypt the Access Key, a Timestamp, a Token Serial Number, a Hash value of the above request address and a status value, and may be represented as:

E_{tek-AT}(Access Key, Timestamp, Token Serial Number, Hash (request address), Status, Hash)

Wherein tek-AT is only set on the security proxy device.

The Access Key is used for an execution module subsequently running on the client, and used to encrypt the request upon sending the request to the server.

The Token Serial Number is used to indicate a serial number of the Token; when the security proxy device assigns a token, the Token Serial Number assigned each time is different, but Token Serial Numbers of different types of tokens assigned in the same step are identical. For example, in addition to the Access Token, a Client Status Request Token may be assigned in the step, and the two tokens employ the same Token Serial Number.

The Status is used to identify a status of the client. In normal situations, a valid status sets a value of the Status to 1. When requests among the requests from the client exceeding a preset threshold number in a preset time period do not carry a Client Status Token, or a large number of illegal requests are received from the client, the value of the Status is configured to 0 (the security proxy device may refuse subsequent requests carrying the Status value 0 directly or in a random manner). The situation that the client carries the Client Status Token will be discussed in subsequent depictions.

Finally, the Hash denotes a Hash value derived from the previous parameters Access Key, Timestamp, Token Serial Number, Hash(request address) and Status, and is mainly used by a data receiver to verify data integrity. The meaning of Hash also applies to subsequent depictions.

Furthermore, the security proxy device may further assign to the client a Client Status Request Token which, together with a Client Status Request Key, is sent. The Client Status Request Token may be obtained by using the Client Status Request Token Key tek-CSRT to encrypt the data containing the Client Status Request Key, for example, the Client Status Request Token may be obtained by using tek-CSRT Timestamp, Token Serial Number, a Hash value of a current address and Client Status Request Key to perform encryption, and may be represented as:

E_{tek-CSRT}(Timestamp, Token Serial Number, Hash (request address), Client Status Request Key, Hash)

Wherein tek-CSRT is only set on the security proxy device.

The execution module sent to the client may take a form of a client code. The execution module may run at the client so that the client can, on the one hand, execute subsequent step 205 to check a client status, and on the other hand, execute subsequent step 207, namely, send the request to the server in the manner of step 207.

The above token, token key, return data from the server and execution module may be inserted into a data message returning to the client. Furthermore, what are inserted into the data message may further comprise: security proxy device encryption buffer information Proxy Encrypted Cookie and illegal attack trapping module. Wherein the Proxy Encrypted Cookie is mainly used to carry session information or contextual information with respect to the client so that when the security proxy device, upon failure, is switched to another security proxy device for processing, the another security proxy device can continue to process according to these session information or contextual information to thereby improve reliability. The illegal attack trapping module may include some bogus URLs. If the client receiving the data is an attacking client, usually the illegal code running in the client will obtain these bogus URLs so as to launch an attack, then there will be a request transmitted by the client device to the bogus URL, and then it can be recognized that the client is an attacking client.

In 205, the execution module of the client uses the Client Status Request Key to encrypt a random number R-CSRT, and then sends the encrypted random number and the Client Status Request Token assigned to the client to the security proxy device. The R-CSRT is a random number generated by the execution module of the client.

Wherein, the Client Status Request Key may comprise two independent keys: Client Status Request Encryption Key and Client Status Request Hash Key. The Client Status Request Encryption Key may be used to encrypt the R-CSRT, which is represented as E_{CSREK}(R-CSRT). In addition, the Client Status Request Hash Key is used to obtain a Hash value for the R-CSRT, which is represented as H_{CSRHK}(R-CSRT). The E_{CSREK}(R-CSRT), H_{CSRHK}(R-CSRT) as well as the Client Status Request Token are sent to the security proxy device.

The Client Status Request Token assigned by the security proxy device each time is different to ensure that each Client Status Request Token can only be used once.

In 206, the security proxy device checks whether the received Client Status Request Token is valid, and verifies the received random number R-CSRT, and uses the Client Status Request Token to encrypt the data containing the Client Status Token and then returns it to the client if the Client Status Request Token is valid and the random number passes the validation.

Wherein, if the Client Status Request Token is a Client Status Request Token assigned for the client and not yet used by the client, the Client Status Request Token will be considered as being valid; if the Client Status Request Token has already been used by the client or is not a Client Status Request Token assigned for the client, the Client Status Request Token will be considered as being invalid.

When the received random number R-CSRT is validated, the Client Status Request Encryption Key may be used to decrypt the E_{CSREK}(R-CSRT) to obtain the R-CSRT, and then uses H_{CSRHK}(R-CSRT) to verify the R-CSRT.

When the Client Status Request Key is used to encrypt the data containing the Client Status Token, the Client Status Request Encryption Key may be specifically used to encrypt the R-CSRT, R-CST and Client Status Token, which is represented as:

E_{CSREK}(R-CST, R-CSRT, Client Status Token, Hash).

In addition, before the E_{CSREK}(R-CST, R-CSRT, Client Status Token, Hash) is returned, the Proxy Encrypted Cookie may be further validated (the execution module may feed back again the Proxy Encrypted Cookie sent by the security proxy device to the client), i.e., verify whether the Proxy Encrypted Cookie sent by the execution mode is consistent with the Proxy Encrypted Cookie stored by itself: the validation succeeds if they are consistent, and the validation fails if they are not consistent.

Check may be further performed as to whether the Timestamp expires.

When the Proxy Encrypted Cookie validation passes and the Timestamp does not expire, E_{CSREK}(R-CST, R-CSRT, Client Status Token, Hash) is returned to the client.

Wherein the Client Status Token is obtained by using the client status token key tek-CST to encrypt the Timestamp, a Token Serial Number, a Hash value of the request address and a status value, and may be represented as:

E_{tek-CST}(Timestamp, Token Serial Number, Hash (request address), Status', Hash)

Wherein Status' is used to indicate whether the received Client Status Request Token is valid. When the received Client Status Request Token is valid, the value of Status' is 1; when the received Client Status Request Token is invalid, the value of Status' is 0.

In 207, the client first uses the Client Status Request Key to decrypt the data returned by the security proxy device to obtain the Client Status Token, and uses the Access Token and Client Status Token to send a request to the server, and the data contained in the request may be encrypted by using the Access Key, as represented as Enc(req1) in the figure.

In this step, the Client Status Request Encryption Key may be specifically used to decrypt the data returned by the security proxy device to obtain the R-CSRT, R-CST, and Client Status Token; then, the R-CSRT and Hash are validated: use the Client Status Token to send the request to the server if the validation succeeds; return wrong information to the security proxy device if the validation fails.

In this step, different processing may be performed according to the specific request sent by the client, and be classified into the following cases:

The first case: the request sent by the client to the server is an ordinary address request which may be sent together with the Access Token and Client Status Token.

The second case: the request sent by the client to the server is an ordinary form request, the Access Key may be used to encrypt the form data, and the encrypted data together with the Access Token and Client Status Token are sent.

The third case: the request sent by the client to the server includes generated address and form data, the Access Key may be used to encrypt the request address and form data, and the encrypted request address and form data together with the Access Token and Client Status Token are sent.

In the above three cases, the token may be attached to the request address, a request header or encrypted data.

Optionally, besides the data contained in the request are encrypted, the encrypted data may further comprise a Hash value of the data contained in the request, which is mainly used to perform data validation.

In 208, the security proxy device verifies the received Client Status Token and Access Token, and then forwards the decrypted request to the server if the validation succeeds.

In essence, after the security proxy device receives the request from the client, it first judges whether a valid token is assigned to the client. If the valid token is not yet assigned to the client and the request is sent to a designed server, the request is directly forwarded to the server in the manner stated in 201. If the request is not sent to the designated server, the request may be refused. If the valid token is already assigned to the client, judgment is made as to whether there is a token assigned to the client and sent together with the request. The request is forwarded to the server if there is; otherwise the forwarding of the request will be refused. Alternatively, times that the request sent by the client does not carry the Client Status Token are recorded, and the processing of the request will be refused when requests among the client's requests exceeding a preset threshold number in a preset time period do not carry the Client Status Token.

In addition to validation to the token, the following validations or checks may be further performed: validating the Proxy Encrypted Cookie, checking whether the request includes an illegal header, checking integrity of the header of the request and the request address, checking whether the header of the request and the request address have the attack code, checking whether the data content of the request includes the attack code, and the like. After successful pass of these validations or checks, the request may be forwarded to the server.

In addition, if the request is an encrypted request, the Access Key is used to decrypt the request and then forward it to the server. If the request is a non-encrypted request, it is directly forwarded to the server.

The Client Status Token may be used to check an operation status of the execution module. If requests among the client's requests exceeding a preset threshold number in a preset time period do not carry the Client Status Token, it may be determined that the execution module operates abnormally and the client is in an invalid state. When a new Access Token is assigned to the client in 210 subsequently, the value of the Status is configured to 0.

Step 209 is identical with step 203.

Step 210 is identical with step 204. To distinguish returned data in steps 203 and 204 from the assigned token and key, in the figure the returned data from the server in steps 209 and 210 is represented as Data1, and the assigned token and key are represented as Access Token1 and Access Key1 respectively.

In the subsequent interaction process, the above steps 205-210 are executed repeatedly.

Noticeably, the above steps 205-206 are mainly used to check whether the execution module in the client operates normally, namely, whether the client normally runs the execution code sent by the security proxy device to the client, and they are not steps that must be executed. If the steps 205-206 are not executed, the Client Status Request Token needn't be assigned and sent to the client in step 204. In step 207, the Client Status Token may not be employed, and instead the Access Token is employed to send the request.

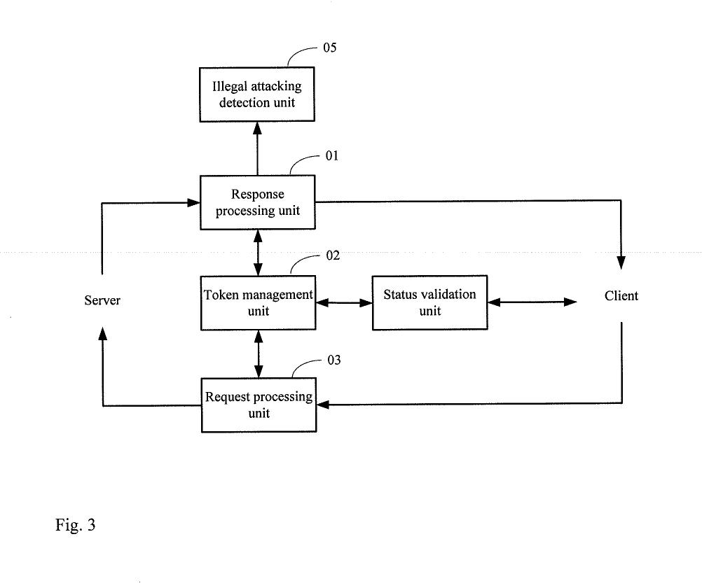

The above describes the method provided by the present invention. The apparatus provided by the present invention will be described below in detail. FIG. 3 is a block diagram of an apparatus according to an embodiment of the present invention. The apparatus may be arranged in the aforesaid security proxy device. As shown in FIG. 3, the apparatus may comprise: a response processing unit 01, a token management unit 02 and a request processing unit 03, and may further comprise a status validation unit 04 and an illegal attack detection unit 05, wherein the above units have the following main functions:

The response processing unit 01 is responsible for processing the data returned by the server to the client, mainly comprising: receiving the data returned by the server to the client, and sending the token assigned to the client, the data returned by the server to the client and the execution module to the client.

The token management unit 02 is responsible for assigning the token to the client and performing management and validation to the token. The functions of the token management unit 02 mainly comprise: assigning the token to the client after the response processing unit 01 receives the data returned by the server to the client; validating the token provided by the request processing unit 03.

The request processing unit 03 is responsible for processing the data sent by the client to the server. Its function mainly comprise: receiving a request which the execution module running at the client uses the token to send, providing the token to the token management unit 02, and forwarding the request to the server if the token validation succeeds. If the token validation fails or the received request does not carry the token assigned to the client, the request processing unit 03 may refuse to process the request.

After the request processing unit 03 receives the request sent by the client to the designated server, the token management unit 02 may be first triggered to judge whether a valid token has already been assigned to the client. If a judgment result of the token management unit 02 is no, the request is forwarded to the server. This situation corresponds to the case shown by 202 in FIG. 2. If the judgment result of the token management unit 02 is yes, judgment will be performed as to whether the request carries a token. If the request carries the token, an operation of providing the token to the token management unit 03 will be executed. This situation corresponds to the case shown by 208 in FIG. 2.

After the request processing unit 03 receives the above request, it may perform validation for the request, and it may refuse to process the request if the validation fails. Specifically, any one or any combination of the following validations may be executed:

Validating whether the protocol header of the request complies with a protocol-specified type;

Performing grammar validation to the protocol header of the request and the request address;

Validating whether the protocol header of the request and the request address include an attack code; and

Performing authentication to the request address of the request.

When the token management unit 02 assigns the token to the client, the access token key may be used to encrypt the data containing the access key to obtain an access token. Correspondingly, the request sent by the execution module carries the access token. At this time, the data containing the access key further comprises any one or any combination of the following data: a Timestamp, a Token Serial number, a Hash value of the request address and a Client Status Value. For example, it may be represented as E_{tek-AT}(Access Key, Timestamp, Token Serial Number, Hash (request address), Status, Hash), i.e., tek-AT is used to encrypt the Access Key, Timestamp, Token Serial Number, Hash value of the above request address and the status value.

The Token Serial Number is used to indicate a serial number of the Token; when the security proxy device assigns a token, the Token Serial Number assigned each time is different, but Token Serial Numbers of different types of tokens assigned in the same step are identical. For example, in addition to the Access Token, a Client Status Request Token may be assigned in the step, and the two tokens employ the same Token Serial Number.

The Client Status Value Status is configured according to whether the request sent by the client carries a correct token or whether it is valid. For example, in normal situations, a valid status sets a value of the Status as 1. When requests among the requests from the client exceeding a preset threshold number in a preset time period do not carry the Client Status Token, or a large number of illegal requests are received from the client, the value of the Status is configured as 0 (the security proxy device may refuse, directly or in a random, the request using a token with the Status value 0).

As already mentioned above, when the token management unit 02 assigns the token to the client, the client status request token may be further assigned. Correspondingly, upon sending the token assigned to the token, the data returned by the server to the client, and the execution module to the client, the response processing unit 01 further sends the client status request token and the client status request key.

The execution module running at the client may send the client status request token to the security proxy device after receiving the data returned by the server. At this time, the status validation unit 04 receives the client status request token sent by the execution module; after the client status request token is confirmed as being valid, the token management unit 02 is triggered to assign a client status token to the client, and sends to the client the client status token encrypted by using the client status request key.

The above operations correspond to 204-206 in FIG. 2.

A request sent by a subsequent execution module further carries the client status token, that is, upon sending the request to the server, the subsequent execution module may only carry the access token, or may carry the access token and the client status token.

When the token management unit 02 assigns the client status token to the client, the client status request token key may be used to encrypt the data containing the client status request key to obtain the client status token. For example, the client status token may be obtained by using the client status token key tek-CST to encrypt the Timestamp, the Token Serial number, the Hash value of the request address and the status value Status, which may be represented as follows:

E_{tek-CST}(Timestamp, Token Serial Number, Hash (request address), Status', Hash)

Wherein the Status' is used to indicate whether the received Client Status Request Token is valid. When the received Client Status Request Token is valid, a value of the Status' is 1; when the received Client Status Request Token is invalid, a value of the Status' is 0.

When the status validation unit 04 verifies whether the client status request token is valid, it may be judged whether the received client status request token is the client status request token assigned to the client and is not yet used by the client (in the embodiment of the present invention, the client status request status assigned to the client usually can be used only once). The client status request token is determined as being valid if yes; otherwise the client status request token is determined as being invalid.

Preferably, the Client Status Request Key may comprise: Client Status Request Encryption Key and Client Request Hash Key. The status validation unit 04 may use the Client Status Request Encryption Key to encrypt the Client Status Token.

In this case, the execution module running at the client may use the Client Status Request Encryption Key to encrypt a random number R-CSRT, and use the Client Request Hash Key to obtain a Hash value for the random number R-CSRT, and then send the encrypted random number and Hash value to the security proxy device. Upon reception, the status validation unit 04 uses the Client Status Request Encryption Key to decrypt the received random number, then uses the Hash value to verify the random number obtained after decryption; after the validation succeeds, an operation of assigning the client status token to the client is executed.

Preferably, when the response processing unit 01 sends the token assigned to the client, the data returned by the server to the client and the execution module to the client, an illegal attack trapping module may be further sent and includes URLs. If the client receiving the data is an attacking client, usually the illegal code running in the client will obtain these bogus URLs so as to launch an attack, and then there will be a request transmitted by the client device to the bogus URL. If the illegal attack detection unit 05 detects the request with respect to the bogus URLs, the client sending the request with respect to the bogus URLs is determined as an attacking client.

In addition, when the response processing unit 01 sends the token assigned to the client, the data returned by the server to the client and the execution module to the client, the access key may be further sent to the client. The execution module running in the client may encrypt the data contained by the request by using the access key, and then send it to the server. At this time, the request processing unit 03, upon forwarding the request to the server, may use the access key to decrypt the data contained by the request, and forward the decrypted request to the server.

In the embodiments of the present invention, it should be understood that the devices and methods disclosed can be implemented through other ways. For example, the embodiments for the devices are only exemplary, e.g., the division of the units is merely logical one, and, in reality, they can be divided in other ways.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present invention, functional units can be integrated in one processing unit, or they can be separate physical presences; or two or more units can be integrated in one unit.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present invention. The aforementioned storage medium includes various media that may store program codes, such as U disk, removable hard disk, read-only memory (ROM), a random access memory (RAM), magnetic disk, or an optical disk.

The foregoing is only preferred embodiments of the present invention, not intended to limit the invention. Any modifications, equivalent replacements, improvements and the like made within the spirit and principles of the present invention, should all be included in the present invention within the scope of protection.

What is claimed is:

1. A secure communication method, wherein the method is executed by a security proxy device between a client and a server, the method comprising:
S1: after receiving data returned by the server to the client, assigning a token to the client, and sending the token, the data returned by the server to the client and an execution module to the client;
S2: receiving a request which the execution module running at the client uses the token to send, validating the token, and forwarding the request to the server if the validation succeeds.

2. The method according to claim 1, wherein the method further comprises:
after receiving the request sent by the client to the server, judging whether a valid token has already been assigned to the client, and forwarding the request to the server if no judging whether the request carries a token if yes, and executing the step of validating the token if the request carries a token.

3. The method according to claim 1, wherein the method further comprises:
performing validation for the request, and refusing to process the request if the validation fails;
the validation comprises any one or any combination of the following:
validating whether a protocol header of the request complies with a protocol-specified type;
performing grammar validation to the protocol header of the request and a request address;
validating whether the protocol header of the request and the request address contain an attack code; and
performing authentication to the request address of the request.

4. The method according to claim 1, wherein the assigning a token to the client comprises: using an access token key to encrypt data containing the access key to obtain an access token;
in the step S2, the request sent by the execution module carries the access token.

5. The method according to claim 4, wherein the data containing the access key further comprises any one or any combination of the following data:
a Timestamp, a Token Serial number, a Hash value of the request address and a Client Status Value;
wherein the Client Status Value is configured according to whether the request sent by the client carries a correct token or whether it is valid.

6. The method according to claim 4, wherein the token assigned to the client further comprises a Client Status Request Token;
what are sent to the client in the step Si further comprise the Client Status Request Token and a Client Status Request Key;
between the step S1 and the step S2, the method further comprises:
S31: receiving the Client Status Request Token sent by the execution module;
S32: after confirming the Client Status Request Token is valid, assigning a Client Status Token to the client, and sending to the client the Client Status Token encrypted by using the Client Status Request Key;
in the step S2, the request sent by the execution module further carries the Client Status Token.

7. The method according to claim 6, wherein the Client Status Request Token is obtained by using a Client Status Request Token Key to encrypt the data containing the Client Status Request Key.

8. The method according to claim 6, wherein in the step S2, validating the Client Status Request Token comprises:
judging whether the received Client Status Request Token is the Client Status Request Token assigned for the client and has not yet been used by the client, confirming that the Client Status Request Token is valid if yes; otherwise confirming that the Client Status Request Token is invalid.

9. The method according to claim 6, wherein the Client Status Request Key comprises: a Client Status Request Encryption Key and a Client Request Hash Key;
in the step S32 the Client Status Request Encryption Key is used to encrypt the Client Status Request Token;
the step S31 further comprises receiving a random number encrypted by using the Client Status Request Encryption Key and a Hash value obtained by using the Client Request Hash Key to hash the random number;
the step S32 further comprises: using the Client Status Request Encryption Key to decrypt the received random number, and then validating the decrypted random number by using the Hash value; and executing the step of assigning the Client Status Token to the client after the validation succeeds.

10. The method according to claim 1, wherein in the step S2, forwarding the request is refused if the validation of the token fails or the received request does not carry the token.

11. The method according to claim 1, wherein what are sent to the client in the step S1 further comprise: an illegal attack trapping module containing a bogus URL;
if a request with respect to the bogus URL is detected, it is determined that the client sending the request with respect to the bogus URL is an attacking client.

12. The method according to claim 4, wherein the step S1 further comprises:
sending the Access Key to the client;
in the step S2, the forwarding the request to the server comprises: using the Access Key to decrypt the data contained by the request, and forwarding the decrypted request to the server.

13. A secure communication apparatus, wherein the apparatus is between a client and a server, the apparatus comprising: a response processing unit, a token management unit and a request processing unit;
the response processing unit is used to receive data returned by the server to the client, and send the token assigned to the client, the data returned by the server to the client and an execution module to the client;
the token management unit is used to assign the token to the client after the response processing unit receives the data returned by the server to the client; verify the token provided by the request processing unit;
the request processing unit is used to receive a request which the execution module running at the client uses the token to send, provide the token to the token management unit, and forward the request to the server if the token validation succeeds.

14. The apparatus according to claim 13, wherein the request processing unit is further used to receive the request sent by the client to the server, then trigger the token management unit to judge whether a valid token has already been assigned to the client, and forward the request to the server if a judgment result of the token management unit is no; judge whether the request carries a token if the judgment result of the token management unit is yes, and execute an operation of providing the token to the token management unit if the request carries a token.

15. The apparatus according to claim 13, wherein the request processing unit is further configured to perform validation for the request, and refuse to process the request if the validation fails;
wherein the validation comprises any one or any combination of the following:
validating whether a protocol header of the request complies with a protocol-specified type;
performing grammar validation to the protocol header of the request and a request address;
validating whether the protocol header of the request and the request address contain an attack code; and
performing authentication to the request address of the request.

16. The apparatus according to claim 13, wherein upon assigning a token to the client, the token management unit specifically uses an access token key to encrypt data containing the access key to obtain an access token;
the request sent by the execution module carries the access token.

17. The apparatus according to claim 16, wherein the data containing the access key further comprises any one or any combination of the following data:
a Timestamp, a Token Serial number, a Hash value of a request address and a Client Status Value;
wherein the Client Status Value is configured according to whether the request sent by the client carries a correct token or whether it is valid.

18. The apparatus according to claim 16, wherein the apparatus further comprises: a status validation unit;
upon assigning the token to the client, the token management unit further assigns a Client Status Request Token; and after being triggered by the status validation unit, assigns a Client Status Token to the client;
when the response processing unit sends the token assigned to the client, the data returned by the server to the client and the execution module to the client, it further sends the Client Status Request Token and a Client Status Request Key;
the status validation unit is configured to receive the Client Status Request Token sent by the execution module; after confirming that the Client Status Request Token is valid, trigger the token management unit to assign the Client Status Token to the client; and send to the client the Client Status Token encrypted by using the Client Status Request Key;
the request sent by the execution module further carries the Client Status Token.

19. The apparatus according to claim 18, wherein upon assigning the Client Status Token to the client, the token management unit specifically uses the Client Status Request Token Key to encrypt the data containing the Client Status Request Key to obtain the Client Status Token.

20. The apparatus according to claim 18, wherein upon validating whether the Client Status Request Token is valid, the status validation unit is specifically used to:
judge whether the received Client Status Request Token is the Client Status Request Token assigned for the client and has not yet been used by the client, confirming that the Client Status Request Token is valid if yes; otherwise confirming that the Client Status Request Token is invalid.

21. The apparatus according to claim 18, wherein the Client Status Request Key comprises: a Client Status Request Encryption Key and a Client Request Hash Key;
said status validation unit specifically uses the Client Status Request Encryption Key to encrypt the Client Status Token;
said status validation unit further receives a random number encrypted by using the Client Status Request Encryption Key and a Hash value obtained by using the Client Request Hash Key to hash the random number; uses the Client Status Request Encryption Key to decrypt the received random number, and then validates the decrypted random number by using the Hash value; and executes the operation of the triggering the token management unit to assign the Client Status Token to the client after the validation succeeds.

22. The apparatus according to claim 13, wherein the request processing unit refuses to forward the request if the validation of the token fails or the received request does not carry the token.

23. The apparatus according to claim 13, wherein upon sending the token assigned to the client, the data returned by the server to the client and the execution module to the client, the response processing unit further sends an illegal attack trapping module containing a bogus URL;
the apparatus further comprises an illegal attack detection unit used to, if a request with respect to the bogus URL is detected, determine that the client sending the request with respect to the bogus URL is an attacking client.

24. The apparatus according to claim 16, wherein upon sending the token assigned to the client, the data returned by the server to the client and the execution module to the client, the response processing unit further sends the Access Key to the client;
the request processing unit, upon forwarding the request to the server, uses the Access Key to decrypt the data contained by the request, and forwards the decrypted request to the server.
